(19) United States
(12) Patent Application Publication
(10) Pub. No.: US 2015/0055572 A1
(43) Pub. Date: Feb. 26, 2015

(54) WIRELESS COMMUNICATION SYSTEM, COMMUNICATION METHOD, TERMINAL DEVICE, AND BASE STATION

(71) Applicant: Sharp Kabushiki Kaisha, Osaka-shi, Osaka (JP)

(72) Inventors: Katsutoshi Ishikura, Osaka-shi (JP); Shusaku Fukumoto, Osaka-shi (JP); Yoshio Konno, Osaka-shi (JP)

(21) Appl. No.: 14/381,246

(22) PCT Filed: Feb. 28, 2013
(86) PCT No.: PCT/JP2013/055398

§ 371 Date: Aug. 27, 2014

(30) Foreign Application Priority Data
Mar. 19, 2012 (JP) 2012-062064

(51) Int. Cl. H04W 72/04; H04W 72/12

(52) U.S. Cl. CPC H04W 72/048; H04W 72/12
USPC 370/329

(57) ABSTRACT

A more preferable communication control method and the like in a wireless communication system allowing usage of a plurality of wireless transmission methods are provided. The wireless communication system includes at least one base station providing services in accordance with the plurality of wireless transmission methods respectively, and a terminal device connected to the base station. The terminal device notifies the base station about terminal information indicating whether communication using a plurality of wireless transmission methods simultaneously is allowed or not. The base station determines a radio resource to be allocated to the terminal device from radio resources available in each of the plurality of wireless transmission methods, based on the terminal information notified by the terminal device.

### TECHNICAL FIELD

The present invention relates to a wireless communication system, a communication method, a terminal device, and a base station. Particularly, the present invention relates to a configuration allowing usage of a plurality of wireless transmission methods simultaneously.

### BACKGROUND ART

3GPP (Third Generation Partnership Project) has been developing various standards for increasing the speed and capacitance of communication. As a method of increasing the speed and capacitance of communication, the technique of using a plurality of carriers is now being specified. For example, 3GPP is specifying the approach of Multicarrier_HSDPA (High Speed Downlink Packet Access) using a plurality of carriers simultaneously in Release 8. Further, 3GPP is specifying the approach of carrier aggregation using a plurality of LTE (Long Term Evolution) Carriers simultaneously in Release 10.

The approach of performing communication using an HSDPA_Carrier and LTE_Carrier simultaneously based on such technique is now under study (for example, refer to Non-Patent Documents 1-3).

Moreover, Japanese Patent Laying-Open No. 2010-011397 (PTD 1.) discloses a wireless communication device allowing communication through a plurality of frequency channels simultaneously.

Under the current technique, there is known a method of using UE Capability as one method of notifying a base station about the capability of a terminal device. This UE Capability includes the information of available wireless communication systems and frequency bands as the terminal capability of a terminal device.

### CITATION LIST

### Patent Document

### PTD 1: Japanese Patent Laying-Open No. 2010-011397

### Non-Patent Document

Non-Patent Document 1: Nokia Siemens Networks, Nokia, “Aggregating HSDPA and LTE carriers”, 3GPP TSG-RAN WG1 Meeting #64, R1-111060, February 21-25, 2011 Non-Patent Document 2: Huawei, HiSilicon, “Migration scenarios and possible aggregation between HSPA and LTE”, 3GPP TSG RAN WG1 #64, R1-111126, Feb. 21-25, 2011
Non-Patent Document 3: ZTE, “Consideration on the aggregation of LTE and HSPA”, 3GPP TSG-RAN WG1 Meeting #64, R1-111173, Feb. 21-25, 2011
Non-Patent Document 4: 3GPP Organizational Partners, “3rd Generation Partnership Project; Technical Specification Group Radio Access Network; Evolved Universal Terrestrial Radio Access (E-UTRA); Radio Resource Control (RRC); Protocol specification (Release 10)”, 3GPP TS 36.331 V10.4.0 (2011-12)

### SUMMARY OF INVENTION

### Technical Problem

In the wireless communication system employing the carrier aggregation approach performing communication using the aforementioned HSDPA_Carrier and LTE_Carrier simultaneously, i.e. in a wireless communication system allowing usage of a plurality of wireless transmission methods simultaneously, the communication control method related to radio resource allocation and the like has not been studied sufficiently.

An object of the present invention is to provide a more favorable communication control method in a wireless communication system allowing usage of a plurality of wireless transmission methods.

### Solution to Problem

A wireless communication system according to an aspect of the present invention includes at least one base station providing services in accordance with a plurality of wireless transmission methods respectively, and a terminal device connected to the base station. The terminal device includes means for notifying the base station about terminal information indicating whether communication using a plurality of wireless transmission methods simultaneously is allowed or not. The base station includes means for determining a radio resource to be allocated to the terminal device from radio resources available in each of the plurality of wireless transmission methods, based on the terminal information notified by the terminal device.

Preferably, the terminal device includes means for notifying the terminal information in each of the plurality of wireless transmission methods.

Preferably, the terminal device includes means for notifying terminal information in a particular wireless transmission method from the plurality of wireless transmission methods.

Further preferably, the terminal device includes means for performing a cell search for the particular wireless transmission method notifying terminal information, given priority over another wireless transmission method.

Preferably, the terminal device includes means for adding terminal information to UE Capability for transmission.

Preferably, the terminal information includes information defining an available wireless transmission method individually for a downlink and an uplink.

Preferably, the terminal information includes information indicating an available frequency band from frequency bands used in the plurality of wireless transmission methods.

Further preferably, the terminal information includes information indicating which is to be given priority for at least one of the wireless transmission methods and frequency bands.

Preferably, the terminal device includes means for capsulating and inserting terminal information related to one wireless transmission method to UE Capability of another wireless transmission method.

According to another aspect of the present invention, there is provided a wireless communication method of a wireless communication system including at least one base station device providing services in accordance with a plurality of wireless transmission methods respectively, and a terminal device. The wireless communication method includes the steps of notifying terminal information indicating whether communication using a plurality of wireless transmission methods simultaneously is allowed or not from the terminal device to the base station, and determining a radio resource to be allocated to the terminal device from radio resources available at each of the plurality of wireless transmission methods, based on the terminal information notified from the terminal device.

According to still another aspect of the present invention, there is provided a terminal device connected to at least one base station providing services in accordance with a plurality of wireless transmission methods respectively. The terminal device includes means for notifying the base station about terminal information indicating whether communication using a plurality of wireless transmission methods simultaneously is allowed or not, and means for performing communication using a radio resource allocated by the base station based on the terminal information.

A base station according to still another aspect of the present invention includes means for providing services in accordance with a plurality of wireless transmission methods respectively, means for receiving, from a terminal device, terminal information indicating whether communication using a plurality of wireless transmission methods simultaneously is allowed or not, and means for determining a radio resource to be allocated to the terminal device from radio resources available at each of the plurality of wireless transmission methods based on terminal information notified from the terminal device.

### Advantageous Effects of Invention

According to the present invention, a more preferable communication control method can be realized at a wireless communication system allowing usage of a plurality of wireless transmission methods.

### BRIEF DESCRIPTION OF DRAWINGS

FIG. 1 is a schematic diagram representing an overall configuration of a wireless communication system envisaged in an embodiment.

FIG. 2 is a schematic diagram representing a configuration of a terminal device used in the wireless communication system shown in FIG. 1.

FIG. 3 is a schematic diagram representing a configuration of a base station used in the wireless communication system shown in FIG. 1.

FIG. 4 is a schematic diagram representing a device configuration of a base station system 200A that is an exemplified modification used in the wireless communication system shown in FIG. 1.

FIG. 5 is a schematic diagram representing a first structural example of terminal capability information according to the present embodiment.

FIG. 6 is a schematic diagram representing a second structural example of terminal capability information according to the present embodiment.

FIG. 7 is a schematic diagram representing a third structural example of terminal capability information according to the present embodiment.

FIG. 8 is a sequence chart representing communication procedures of a wireless communication system according to a first embodiment.

FIG. 9 is a sequence chart representing communication procedures of a wireless communication system according to the first embodiment.

FIG. 10 is a sequence chart representing communication procedures of a wireless communication system according to a second embodiment.

FIG. 11 is a schematic diagram representing an example of UE Capability in WCDMA transmitted from a terminal device according to a fourth embodiment.

FIG. 12 is a sequence chart representing communication procedures of a wireless communication system according to the fourth embodiment.

### DESCRIPTION OF EMBODIMENTS

Embodiments of the present invention will be described in detail with reference to the drawings. In the drawings, the same or corresponding elements have the same reference characters allotted, and description thereof will not be repeated.

### A. Overall Configuration of Wireless Communication System

FIG. 1 is a schematic diagram representing an overall configuration of a wireless communication system SYS envisaged in an embodiment. Wireless communication system SYS provides services in accordance with a plurality of wireless transmission methods respectively. As a typical example, it is assumed that wireless communication system SYS supports the LTE method and the WCDMA method corresponding to HSDPA/HSUPA.

Referring to FIG. 1, wireless communication system SYS includes a terminal device 100 and a base station 200. For the sake of convenience, FIG. 1 shows a state in which terminal device 100 and base station 200 perform communication in a one-to-one correspondence. However, the number, topology and the like of terminal device 100 and base station 200 can be set appropriately according to the specification and the like required for wireless communication system SYS.

By way of example in FIG. 1, it is assumed that terminal device 100 and base station 200 are performing communication through a plurality of LTE_Carriers and a plurality of WCDMA_Carriers. Specifically, terminal device 100 and base station 200 perform carrier aggregation through a plurality of LTE_Carriers and a plurality of WCDMA_Carriers. By way of example, FIG. 1 shows the implementation of carrier aggregation using three carriers in the LTE method and two carriers in the WCDMA method. The present embodiment corresponds to the case where carrier aggregation is performed through one or more carriers of one wireless transmission method and one or more carriers of another wireless transmission method. The number of carriers used in each wireless transmission method is set appropriately depending on the communication environment or the like.

According to the current specification, each LTE_Carrier has a bandwidth of 20 MHz, and each WCDMA_Carrier has a bandwidth of 5 MHz. Therefore, by using three LTE_Carriers and two WCDMA_Carriers, communication based on a bandwidth of a total of 70 MHz can be performed between terminal device 100 and base station 200.

It is assumed that HSDPA (High Speed Downlink Packet Access) is employed for the downlink of WCDMA, and HSUPA (High Speed Uplink Packet Access) is employed for the uplink.

Although FIG. 1 represents an example in which data is transmitted/received through a plurality of carriers at the same time at both the downlink and uplink, any number of carriers to be used may be set for each of the downlink and uplink. For example, communication may be performed using the five carriers simultaneously shown in FIG. 1 for the downlink and used only one LTE_Carrier among the carriers shown in FIG. 1 for the uplink.

### B. Device Configuration

The device configuration of each entity constituting wireless communication system SYS shown in FIG. 1 will be described first.

### b1: Configuration of Terminal Device 100

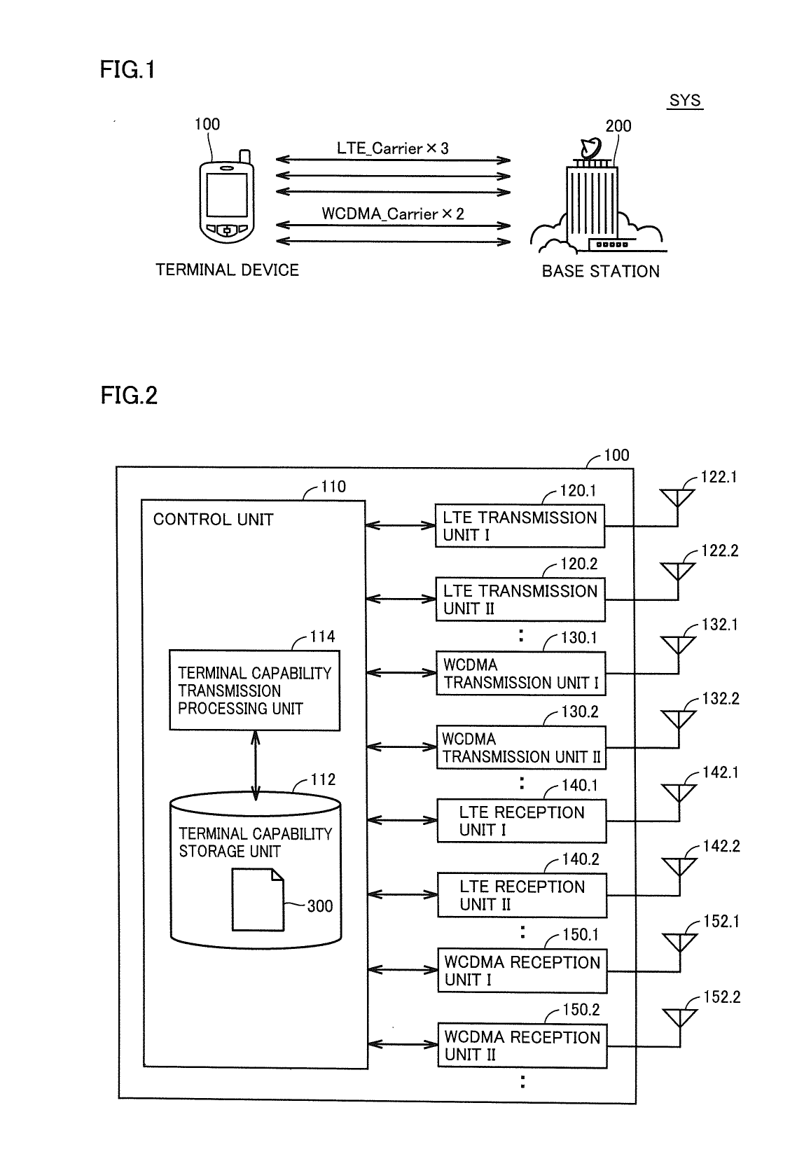

A configuration of a terminal device 100 employed in wireless communication system SYS shown in FIG. 1 will be described. FIG. 2 is a schematic diagram representing a configuration of terminal device 100 employed in wireless communication system SYS shown in FIG. 1.

Referring to FIG. 2, terminal device 100 includes a control unit 110, LTE transmission units 120.1, 120.2, . . . connected to transmission antennas 122.1, 122.2, . . . , WCDMA transmission units 130.1, 130.2, . . . connected to transmission antennas 132.1, 132.2, . . . , LTE reception units 140.1, 140.2, . . . connected to reception antennas 142.1, 142.2, . . . , and WCDMA reception units 150.1, 150. 2, . . . connected to reception antennas 152.1, 152.2, . . . . LTE transmission units 120.1, 120.2, . . . and LTE reception units 140.1, 140.2, . . . transfer data with base station 200 in accordance with the LTE method. WCDMA transmission units 130.1, 130.2 . . . and WCDMA reception units 150.1, 150.2 . . . transfer data with base station 200 in accordance with the WCDMA method. WCDMA transmission units 130.1, 130.2 . . . are capable of HSUPA transmission processing. WCDMA transmission units 150.1, 150.2 . . . are capable of HSDPA reception processing.

It is assumed that terminal device 100 shown in FIG. 2 can be connected with base station 200 through the carrier of a plurality of frequency bands. By way of example, it is assumed that two frequency bands (frequency bands I and II) are available as the plurality of frequency bands. In FIG. 2, “I” and “II” assigned to a block corresponding to each of the LTE transmission unit, WCDMA transmission unit, LTE reception unit, and WCDMA reception unit in FIG. 2 indicate the correspondence to frequency band I and frequency band II, respectively.

Frequency bands I and II represent the available frequency band envisaged in wireless communication system SYS. Such frequency bands are matters depending upon the electric wave governmental administration in each country. For example, 2 GHz band (downlink: 2110 MHz-2170 MHz/uplink: 1920 MHz-1980 MHz) and 800 MHz band (downlink: 869 MHz-894 MHz/uplink: 824-849 MHz) and the like are envisaged.

Although FIG. 2 depicts the transmission unit and reception unit as independent structure, elements that can have the process shared may be configured as a common element. Alternatively, the transmission unit and reception unit may be arranged in parallel. For example, in the case where communication is to be performed using a plurality of LTE_Carriers simultaneously in frequency band I, a plurality of LTE reception units 122.1 corresponding to frequency band I may be provided.

Control unit 110 controls the communication process at LTE transmission units 120.1, 120.2 . . . , WCDMA transmission units 130.1, 130.2 . . . , LTE reception units 140.1, 140.2, . . . and WCDMA reception units 150.1, 150. 2, . . . . Control unit 110 is the processing entity configured based on a processor and memory.

Control unit 110 includes, as a functional structure, a terminal capability storage unit 112 and a terminal capability transmission processing unit 114. Terminal capability storage unit 112 stores terminal capability information 300 that indicates the capability of terminal device 100. For example, terminal capability information 300 includes UE Capability and the like defined in the 3GPP specification. Details of terminal capability information 300 according to the present embodiment will be described afterwards. Terminal capability transmission processing unit 114 carries out the process involved in transmitting terminal capability information 300 stored in terminal capability storage unit 112 to base station 200.

In addition to the above-described process related to terminal capability information 300, control unit 110 carries out various control required to allow communication between terminal device 100 and base station 200 such as processing on reception data and transmission data, and involved in Carrier frequency control at a transmission unit and reception unit,. Although not shown, programs, modules and the like required for such control are also incorporated in control unit 110.

### b2: Configuration of Base Station 200

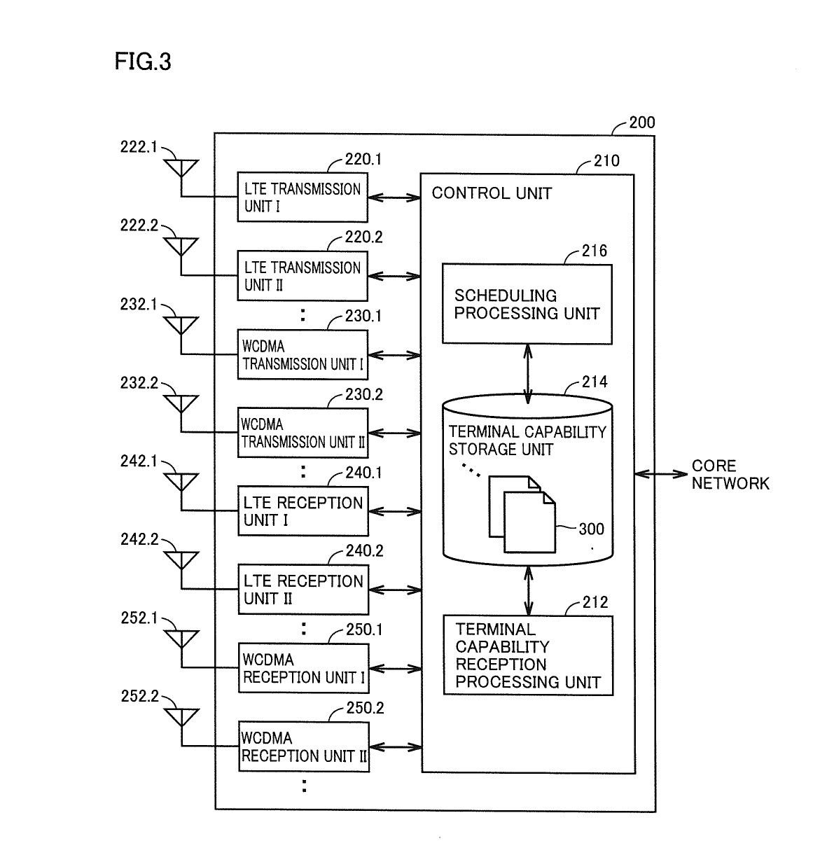

A configuration of base station 200 employed in wireless communication system SYS shown in FIG. 1 will be described. FIG. 3 is a schematic diagram representing a configuration of base station 200 employed in wireless communication system SYS shown in FIG. 1.

Referring to FIG. 3, base station 200 includes a control unit 210, LTE transmission units 220.1, 220.2, . . . connected to transmission antennas 222.1, 222.2, . . . , WCDMA transmission units 230.1, 230.2 . . . connected to transmission antennas 232.1, 232.2, . . . , LTE reception units 240.1, 240.2, . . . connected to reception antennas 242.1, 242.2, . . . , and WCDMA reception units 250.1, 250.2, . . . connected to reception antennas 252.1, 252.2, . . . . LTE transmission units 220.1, 220.2 . . . and LTE reception units 240.1, 240.2, . . . transfer data with terminal device 100 in accordance with the LTE method. WCDMA transmission units 230.1, 230.2 . . . and WCDMA reception units 250.1, 250.2, . . . transfer data with terminal device 100 in accordance with the WCDMA method. WCDMA transmission units 230.1, 230.2 are capable of HSDPA transmission processing. WCDMA reception units 250.1, 250.2, . . . are capable of HSUPA reception processing.

It is assumed that base station 200 shown in FIG. 3 can communicate through the carrier of a plurality of frequency bands. In other words, base station 200 provides services in accordance with a plurality of wireless transmission methods respectively. By way of example, it is assumed that two frequency bands (frequency bands I and II) are available as the plurality of frequency bands. In FIG. 3, “I” and “II” assigned to a block corresponding to each of the LTE transmission unit, WCDMA transmission unit, LTE reception unit, and WCDMA reception unit indicate the correspondence to frequency band I and frequency band II, respectively, likewise with terminal device 100 set forth above.

Although FIG. 3 depicts the transmission unit and reception unit as an independent structure, elements that can have the process shared may be configured as a common element. Alternatively, the transmission unit and reception unit may be arranged in parallel. For example, in the case where communication is to be performed using a plurality of LTE_Carriers simultaneously in frequency band I, a plurality of LTE reception units 240.1 corresponding to frequency band I may be provided.

Control unit 210 controls the communication process at LTE transmission units 220.1, 220.2 . . . , WCDMA transmission units 230.1, 230.2 . . . , LTE reception units 240.1, 240.2, . . . and WCDMA reception units 250.1, 250. 2, . . . . Control unit 210 is the processing entity configured based on a processor and memory.

Control unit 210 includes, as the functional structure, a terminal capability reception processing unit 212, a terminal capability storage unit 214, and a scheduling processing unit 216.

Terminal capability reception processing unit 212 executes the process of receiving terminal capability information 300 from each terminal device 100, and stores the received terminal capability information 300 in terminal capability storage unit 214.

Terminal capability storage unit 214 stores terminal capability information 300 from one or more terminal devices 100 performing communication with its base station. By way of example, terminal capability information 300 is inserted in UE Capability or the like defined in the 3GPP specification.

Scheduling processing unit 216 refers to terminal capability information 300 stored in terminal capability storage unit 214 to appropriately allocate a radio resource to each terminal device 100. At this stage, scheduling processing unit 216 executes radio resource allocation taking into account the radio quality and the like at each terminal device 100.

In addition to the scheduling process set forth above, control unit 210 carries out various control for communication between base station 200 and terminal device 100 such as control involved in processing on reception data and transmission data as well as Carrier frequency control at a transmission unit and reception unit. Although not shown, programs, modules and the like required for such control are incorporated in control unit 210.

### b3: Configuration of Base Station 200 (Exemplified Modification)

A configuration of intrasite carrier aggregation may be employed instead of the configuration of base station 200 shown in FIG. 3.

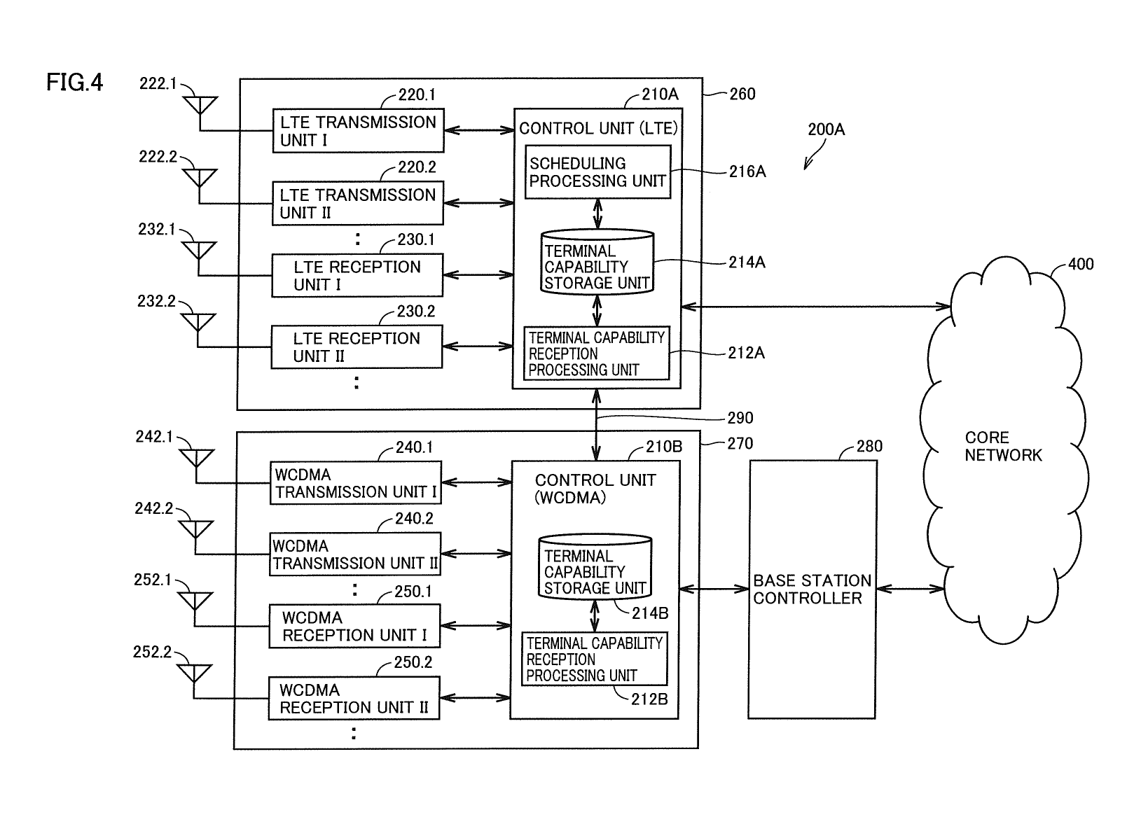

FIG. 4 is a schematic diagram of a device configuration of base station system 200A of an exemplified modification used in wireless communication system SYS shown in FIG. 1. Referring to FIG. 4, base station system 200A includes an LTE base station 260, a WCDMA base station 270 and a base station controller 280.

LTE base station 260 is a device providing service in accordance with the LTE method, controlling allocation of an LTE radio resource and the like. WCDMA base station 270 is a device providing service in accordance with the WCDMA method, controlling allocation of a WCDMA radio resource and the like. Base station controller 280 is connected between core network 400 and WCDMA base station 270 to control allocation of WCDMA radio resource and the like at WCDMA base station 270.

LTE base station 260 is directly connected to core network 400. LTE base station 260 and WCDMA base station 270 transfer control information, user data, and the like via LTE base station 260 and core network 400. Alternatively, LTE base station 260 and WCDMA base station 270 may be directly connected (LTE-WCDMA base station interconnection 290).

At base station system 200A shown in FIG. 4, the scheduling process according to the present embodiment (the process of allocating a radio resource to each terminal device 100) may be executed at, for example, control unit 210A of LTE base station 260. FIG. 4 shows an example where control unit 210A of LTE base station 260 executes scheduling process.

Specifically, control unit 210A of LTE base station 260 includes, as the functional structure, a terminal capability reception processing unit 212A, a terminal capability storage unit 214A, and a scheduling processing unit 216A. WCDMA base station 270 includes, as a functional structure, a terminal capability reception processing unit 212B, and a terminal capability storage unit 214B.

When carrier aggregation is to be performed through an LTE_Carrier and WCDMA_Carrier (HSDPA) based on the configuration set forth above, control unit 210A of LTE base station 260 determines the radio resource of each LTE and HSDPA to be allocated for carrier aggregation. Then, control unit 210A of LTE base station 260 transmits the radio resource information to control unit 210B of WCDMA base station 270 via an LTE-WCDMA base station interconnection 290 or the like.

As an alternative method, a core network control device (not shown) arranged on core network 400 may carry out the scheduling process. In this case, the radio resource of each of LTE and HSDPA to be allocated for carrier aggregation is notified from the core network control device to control unit 210A of LTE base station 260 and control unit 210B of WCDMA base station 270.

### b4: Other Configuration

The functions of terminal device 100, base station 200 and base station system 200A may be realized by a processor of the control unit executing a program prestored in a non-volatile memory or the like. In this case, a set of instructions installed in advance will be executed by an operation entity such as a CPU (Central Processing Unit) or DSP (Digital Signal Processor).

Alternatively, a portion or all of the functions may be implemented as dedicated hardware (typically, an integrated circuit). In this case, circuitry realizing all the functions may be implemented as one chip. Moreover, a SoC (System On a Chip) having components such as a processor, memory, and controller for a peripheral device implemented as one chip may be employed.

### C. Overview of Problem and Solving Means

In order to realize carrier aggregation using an LTE_Carrier and WCDMA_Carrier (HSDPA_Carrier) simultaneously between a terminal device 100 and a base station 200, as shown in FIG. 1, wireless communication system SYS must know in advance that terminal device 100 accommodates carrier aggregation between LTE and WCDMA.

In the case where the frequency band available for the carrier aggregation of LTE and WCDMA at terminal device 100 is restricted, wireless communication system SYS may not be able to allocate appropriately a radio resource to a terminal device 100 even if that terminal device 100 is specified as a device that can execute carrier aggregation.

According to the current art, the method of utilizing UE Capability is known as a method of notifying a base station about the capability of a terminal device. However, details such as how UE Capability is to be used in a wireless communication system allowing usage of a plurality of wireless transmission methods, as set forth above, is not evaluated. In other words, there is no teaching of the method of what wireless transmission method is to be used for notifying information on the capability of a terminal device related to a plurality of wireless transmission methods, and how communication control is to be carried out based on the notified terminal device capability information.

The present embodiment is directed to a wireless communication system in which one or more terminal devices 100 and one or more base stations 200 can use a plurality of wireless transmission methods simultaneously. Each terminal device 100 transmits to base station 200 terminal capability information 300 that is the terminal information indicating whether communication is possible using a plurality of wireless transmission methods simultaneously. In other words, by notifying base station 200 (network side) in advance about terminal capability information 300 of each terminal device 100 (including the information whether relevant terminal device 100 can use a plurality of wireless transmission methods simultaneously), base station 200 (network side) can allocate a radio resource (perform scheduling process) appropriately to each terminal device 100. Namely, base station 200 determines, based on terminal capability information 300 notified from terminal device 100, the radio resource to be allocated to terminal device 100 among radio resources available in each of the plurality of wireless transmission methods.

At wireless communication system SYS according to the present embodiment, information indicating whether communication is allowed using a plurality of wireless transmission methods simultaneously may be added to existing UE Capability notified to base station 200 from terminal device 100. For example, there may be added the information of indicating whether accommodating carrier aggregation of LTE and WCDMA or not to UE Capability used in the LTE method, and information of indicating whether accommodating carrier aggregation of LTE and WCDMA to UE Capability used in the WCDMA method.

By adding the aforementioned terminal capability information 300 to the existing UE Capability, the method of notification from terminal device 100 to base station 200 can be simplified.

Information of accommodating carrier aggregation of LTE and WCDMA or not is to be added to at least either UE Capability used at the LTE method or UE Capability used at the WCDMA method.

Carrier aggregation can be executed more reliably by notifying all the systems monitoring the available wireless transmission methods about terminal capability information 300 of a terminal device 100. Specifically, terminal device 100 adds information indicating whether communication using a plurality of wireless transmission methods simultaneously is allowed or not (terminal capability information 300) to the UE Capability used in the LTE method and sends a notification thereof to base station 200, and adds information indicating whether communication using a plurality of wireless transmission methods simultaneously is allowed or not (terminal capability information 300) to the UE Capability used in the WCDMA method and sends a notification thereof to base station 200. Base station 200 allocates a radio resource to terminal device 100 based on such terminal capability information 300 from terminal device 100.

By sending a notification of terminal capability information 300 of terminal device 100 to all the systems monitoring the available wireless transmission methods, base station 200 can be notified reliably of terminal capability information 300 of terminal device 100, regardless of which system of a wireless transmission method terminal device 100 has been initially connected.

Alternatively, terminal capability information 300 of terminal device 100 may be notified to only one of the systems monitoring the available wireless transmission methods. In this case, terminal device 100 first executes a cell search at the wireless transmission method in which terminal capability information 300 is to be notified. Upon detecting a carrier (cell) in the subject wireless transmission method, terminal device 100 notifies base station 200 corresponding to the detected carrier of terminal capability information 300 of itself. Upon receiving terminal capability information 300 from terminal device 100, base station 200 allocates a radio resource to terminal device 100 based on the received information.

In the case where a carrier could not be detected in the target wireless transmission method, terminal device 100 modifies the wireless transmission method in which terminal capability information 300 is to be notified, and executes again a cell search in another wireless transmission method.

Thus, by employing a control method initiating radio resource allocation by sending a notification of terminal capability information 300 to base station 200 providing one wireless transmission method, and base station 200 receiving terminal capability information 300 from terminal device 100, terminal capability information 300 related to a plurality of wireless transmission methods can be processed efficiently.

### D. Terminal Capability Information

Terminal capability information 300 according to the present embodiment will be described in detail hereinafter. As mentioned above, terminal capability information 300 according to the present embodiment includes information at least indicating whether the relevant terminal device 100 can communicate using a plurality of wireless transmission methods simultaneously.

As a typical example in the present embodiment, terminal capability information 300 including information indicating whether the relevant terminal device 100 can communicate using a plurality of wireless transmission methods simultaneously is added to UE Capability for notification.

Additionally, more detailed terminal capability information 300 including another information of uplink and downlink, and/or information of a frequency band available for carrier aggregation may be notified.

Although the data structure of terminal capability information 300 can be selected appropriately according to the device configuration, application, system capability and the like, a typical data structure of terminal capability information 300 will be exemplified hereinafter. The structure of terminal capability information 300 is not limited to that set forth below.

### d1: First Structural Example of Terminal Capability Information

FIG. 5 is a schematic diagram representing a first structural example of terminal capability information according to the present embodiment. In FIG. 5, the reference character of “300A” is assigned to imply one structural example of terminal capability information 300. Terminal capability information 300A of FIG. 5 includes information of whether terminal device 100 that is the transmission source is capable of carrier aggregation (CA) of LTE and WCDMA. This terminal capability information 300A is typically added to UE Capability transmitted from terminal device 100.

FIG. 5 shows the simplest structural example of terminal capability information 300A. Terminal capability information 300A is used in the case where terminal device 100 can use all the frequency bands provided by wireless communication system SYS for carrier aggregation. In other words, the information is suitable to the case where terminal device 100 is not restricted in the frequency band used for carrier aggregation. Terminal device 100 transmits terminal capability information 300A using the UE Capability in each wireless transmission method.

Referring to FIG. 5, in association with the section of “CA Availability of LTE and WCDMA”, the value of “YES” or “NO” is stored. “YES” and “NO” is set when terminal device 100 of the transmission source is configured to allow and not allow, respectively, carrier aggregation.

Terminal capability information 300A is stored in terminal capability storage unit 112 of each terminal device 100. Terminal capability information 300A transmitted from each terminal device 100 to base station 200 is stored in terminal capability storage unit 214 of base station 200.

### d2: Second Structural Example of Terminal Capability Information

The terminal capability information may be used with the information of whether carrier aggregation (CA) of LTE and WCDMA is available or not, defined for each of downlink and uplink. For example, information such as the carrier aggregation of LTE and WCDMA (HSDPA) being available at the downlink, but not at the uplink (HSUPA) (only LTE can be used) may be included.

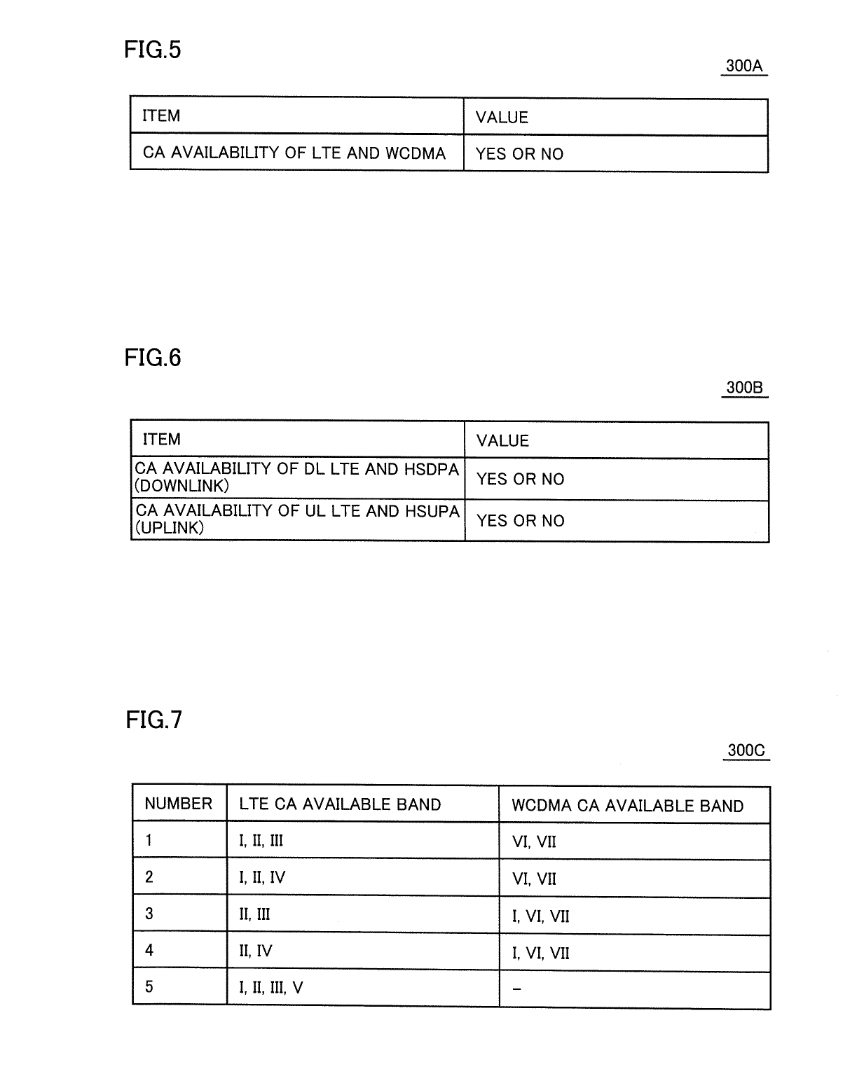

FIG. 6 is a schematic diagram representing a second structural example of terminal capability information according to the present embodiment. In FIG. 6, reference character “300B” is assigned to imply one structural example of terminal capability information 300. FIG. 6 shows terminal capability information 300B defined individually for the downlink and uplink, as compared to terminal capability information 300A shown in FIG. 5. Namely, terminal capability information 300B indicates whether carrier aggregation (CA) of LTE and HSDPA is available or not as the reception capability of terminal device 100, and whether carrier aggregation (CA) of LTE and HSUPA is available or not as the transmission capability of terminal device 100. Specifically, terminal capability information 300B includes information defining the available wireless transmission method, individually for the downlink and uplink.

By using such terminal capability information 300B, a radio resource can be allocated appropriately to a terminal device 100 with carrier aggregation of LTE and HSDPA available as the reception capability, but only accommodating LTE as the transmission capability.

### d3: Third Structural Example of Terminal Capability Information

Terminal capability information including the information of a frequency band available for carrier aggregation may be used. For example, the terminal capability information includes information such as: (1) which frequency band of LTE and which frequency band of HSDPA can be used simultaneously; (2) the number of frequency bands available for carrier aggregation (each maximum value and/or maximum value allowing simultaneous communication); and (3) which wireless transmission method is to be given priority.

FIG. 7 is a schematic diagram representing a third structural example of terminal information according to the present embodiment. In FIG. 7, reference character “300C” is assigned to imply one structural example of terminal capability information 300. FIG. 7 represents terminal capability information 300C further defined with information indicating which frequency band is available for carrier aggregation, as compared to terminal capability information 300A shown in FIG. 5.

In terminal capability information 300C, a combination of frequency bands available in carrier aggregation is defined with an assigned number. For example, number “1” of terminal capability information 300C indicates that carrier aggregation is available through any combination of frequency bands I, II and III of LTE and frequency bands VI, VII of WCDMA. This section of number “1” indicates that carrier aggregation of LTE frequency bands I and II and WCDMA frequency band VI is available. The section of number “1” also indicates that carrier aggregation using all the five defined frequency bands is available. It also indicates that carrier aggregation using only the frequency bands of LTE (for example, frequency bands I, II, and III) is available.

Similarly, terminal capability information 300C indicates that a combination of numbers “2”-“5” is available. For example, the section of number “5” indicates that there is no frequency band available for carrier aggregation of WCDMA, and carrier aggregation of only LTE can be performed when frequency band V of LTE is used for carrier aggregation.

Namely, terminal capability information 300C shown in FIG. 7 includes information indicating an available frequency band among the frequency bands used in a plurality of wireless transmission methods. Moreover, terminal capability information 300C can include information indicating which is to be given priority for at least one of wireless transmission methods and frequency bands.

In the case where terminal capability information 300C shown in FIG. 7 is to be used, the number of combination of frequency bands is preferably defined to be as low as possible in order to minimize the amount of memory in terminal capability storage units 112 and 214.

### d4: (Other) Structural Examples of Terminal Capability Information

Likewise with terminal capability information 300B shown in FIG. 6, terminal capability information 300C shown in FIG. 7 may have the reception capability and transmission capability of terminal device 100 defined individually. By employing such individually defined terminal capability information, the structure of terminal device 100 can be simplified. Namely, since the availability of carrier aggregation between which of the LTE frequency band and which of the WCDMA frequency band is allowed cannot be determined because terminal capability information 300A shown in FIG. 5 includes only the information indicating whether carrier aggregation of LTE and WCDMA is allowed, terminal device 100 must have carrier aggregation accommodation for all the combinations of the frequency bands. In contrast, the usage of terminal capability information 300B shown in FIG. 6 allows terminal device 100 to accommodate carrier aggregation for only the combination of particular frequency bands. Therefore, the configuration of terminal device 100 can be simplified.

Moreover, information of which frequency band is to be used in priority in any wireless transmission method can be added to terminal capability information 300C shown in FIG. 7. The usage of such terminal capability information allows the base station to determine which frequency band in which wireless transmission method is to be used in priority for scheduling in each terminal device 100, leading to more effective usage of the radio resource.

Alternatively, there may be defined information such as the maximum number of carriers available for carrier aggregation at LTE, the maximum number of carriers available for carrier aggregation in WCDMA, the maximum number of carriers available for carrier aggregation based on a combination of LTE and WCDMA, instead of terminal capability information 300C shown in FIG. 7. Moreover, such information may be defined individually for the reception capability and transmission capability of terminal device 100.

### E. First Embodiment

A communication control method between terminal device 100 and base station 200 using UE Capability including terminal capability information 300 set forth above will be described hereinafter.

In the first embodiment, terminal device 100 adds the aforementioned terminal capability information 300 to both the UE Capability in the wireless transmission methods of each of LTE and WCDMA. By employing a notification method of such terminal capability information 300, base station 200 (network side) can be informed of terminal capability information 300 regardless of which wireless transmission method terminal device 100 has camped on.

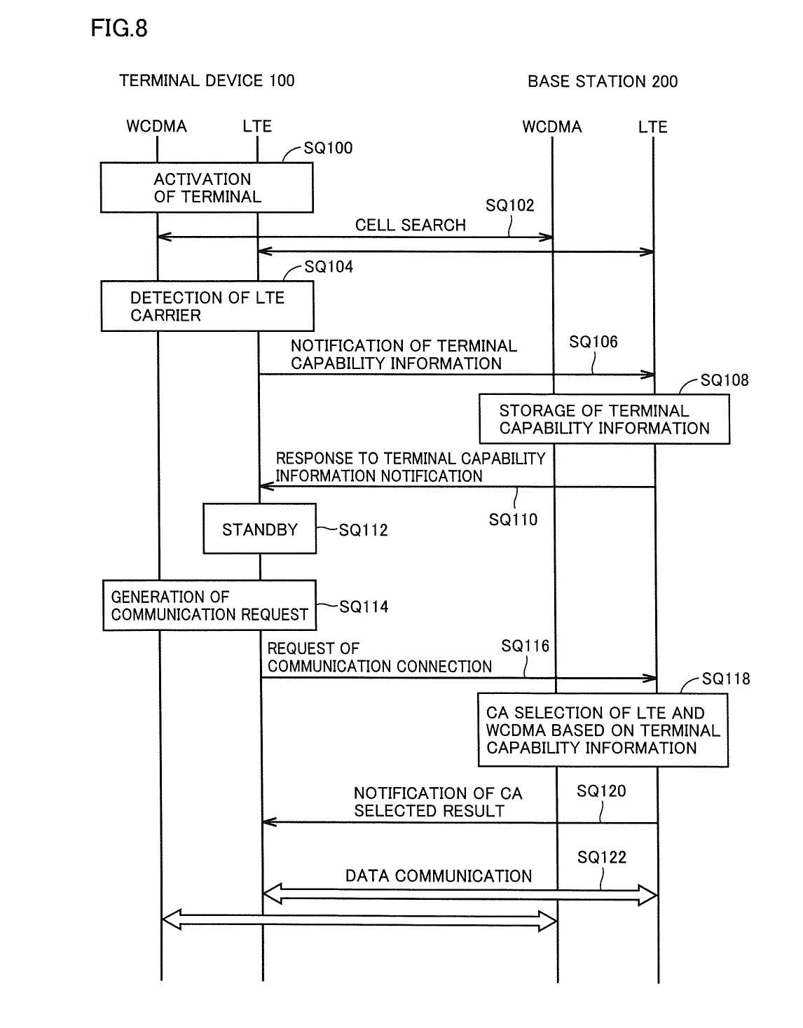

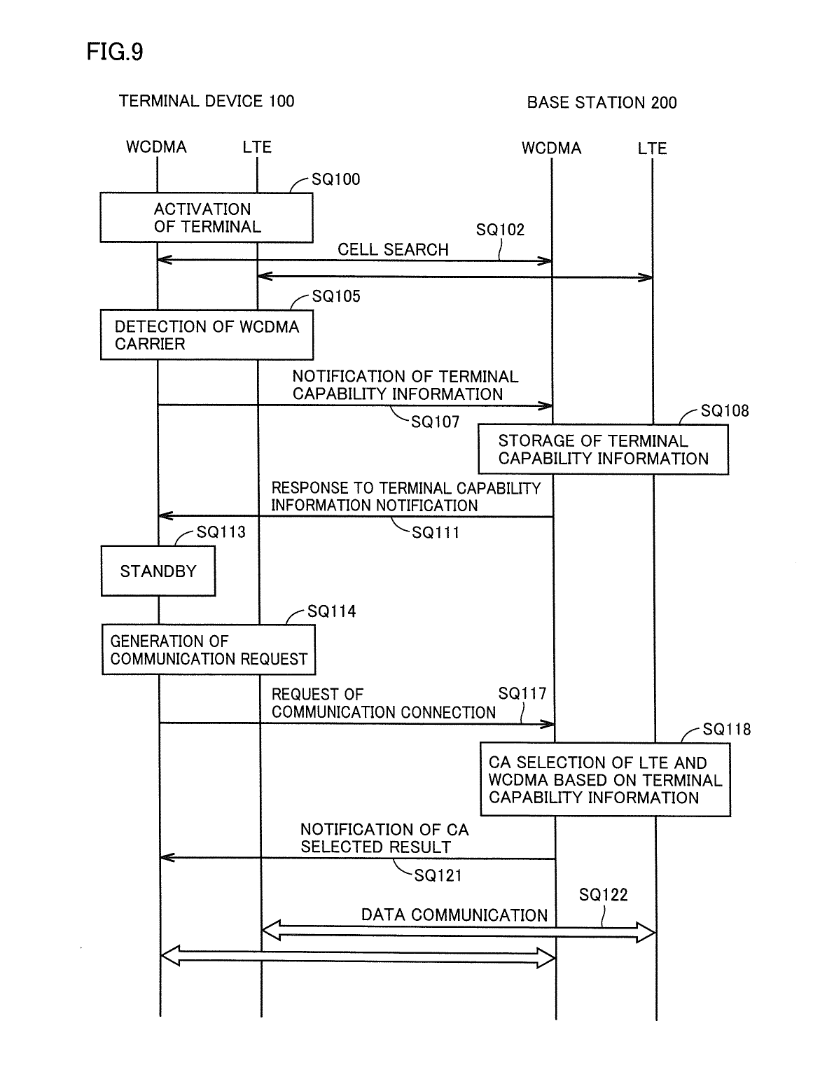

FIGS. 8 and 9 are sequence charts representing communication procedures in a wireless communication system according to the first embodiment. FIG. 8 represents an example in which terminal device 100 first detects an LTE carrier by a cell search, whereas FIG. 9 represents an example in which terminal device 100 first detects a WCDMA carrier by a cell search.

It is assumed that terminal device 100 shown in FIGS. 8 and 9 is capable of carrier aggregation through an LTE_Carrier and WCDMA_Carrier (HSDPA). It is also assumed that terminal capability storage unit 112 of terminal device 100 stores terminal capability information 300 shown in FIGS. 6-8 set forth above.

Referring to FIGS. 8 and 9, when terminal device 100 is activated by a power button being turned ON or the like (sequence SQ100), terminal device 100 initiates a cell search (sequence SQ102). FIG. 8 corresponds to the case where a carrier of LTE is first detected by a cell search (sequence SQ104).

Accordingly, terminal device 100 notifies base station 200 of its terminal capability information 300 through LTE (sequence SQ106). This terminal capability information 300 is typically notified as a part of general information indicating the terminal capability (UE Capability in LTE). Namely, terminal device 100 notifies base station 200 about terminal capability information 300 indicating whether communication is allowed using a plurality of wireless transmission methods simultaneously. At this stage, terminal device 100 adds terminal capability information 300 to UE Capability for transmission.

Upon receiving terminal capability information 300 from terminal device 100 through LTE, base station 200 stores the received terminal capability information 300 in terminal capability storage unit 112 together with the information to identify terminal device 100 that is the transmission source (sequence SQ108). Then, base station 200 transmits to terminal device 100 a response to the notification of terminal capability information 300 through LTE (sequence SQ110). Then, terminal device 100 attains a standby state in LTE (sequence SQ112).

Upon generation of a transmission request of a packet, voice, or the like (sequence SQ114), terminal device 100 requests a communication connection to base station 200 through the LTE currently camped on (sequence SQ116). For example, consider a case where a communication request of a packet of a large data size is generated and data connection is requested. Terminal device 100 may notify radio quality information of a cell capable of communication together with the communication connection request. Moreover, the data size of the transmission subject may be notified together with the communication connection request. The radio quality information of a cell capable of communication may be notified periodically.

Base station 200 responds to a communication connection from terminal device 100 to determine whether carrier aggregation is available or not. Specifically, base station 200 determines the resource to be allocated to terminal device 100 from radio resources available at each of the plurality of wireless transmission methods, based on terminal capability information 300 notified by terminal device 100.

More specifically, scheduling processing unit 216 of base station 200 determines whether carrier aggregation of LTE and WCDMA (HSDPA) is to be performed or not based on the radio quality of a cell capable of communication, the entire traffic amount, whether the data that is the subject of transmission/reception is a packet or voice (and the data size in the case where the data that is the subject of transmission/reception is a packet), corresponding terminal capability information 300, and the like. When a determination is made of performing carrier aggregation, scheduling processing unit 216 of base station 200 determines which frequency bands are used for carrier aggregation. In contrast, when a determination is made that carrier aggregation is not performed, scheduling processing unit 216 of base station 200 determines which of LTE and WCDMA a wireless transmission method is to be used, whether carrier aggregation is to be performed in the selected wireless transmission method, and which frequency band is to be used in the case of performing carrier aggregation, and the like.

For example, in the case where the data size of the transmission subject is relatively small, scheduling processing unit 216 of base station 200 selects a carrier of one of LTE and HSDPA where the traffic amount is low and of favorable radio quality. In this case, carrier aggregation of LTE and WCDMA, and carrier aggregation in the relevant wireless transmission method will not be executed. More specifically, in the case where only voice conversation is requested, a determination is made that WCDMA is always used without taking into account carrier aggregation and the like. In contrast, when a videophone is requested, a determination is made that the voice uses WCDMA whereas the moving picture uses LTE carrier aggregation, i.e. carrier aggregation of LTE and WCDMA.

Moreover, terminal device 100 may notify base station 200 about its remaining amount of battery. In this case, when the remaining amount of battery is low, scheduling may be performed so as to select a method of lower current consumption, for example.

Moreover, terminal device 100 may notify base station 200 about a wireless transmission method with an error or fault. In this case, scheduling may be performed so as to avoid selecting a faulty wireless transmission method.

FIG. 8 represents an example in which communication connection of a large data size is requested. In this example, scheduling processing unit 216 of base station 200 selects carrier aggregation of LTE and WCDMA (HSDPA) (sequence SQ118). Then, base station 200 notifies terminal device 100 about the selected result of carrier aggregation through LTE (sequence SQ120). More specifically, base station 200 notifies terminal device 100 about the frequency band to be used in LTE and the frequency band to be used in WCDMA (HSDPA).

According to the notified selected result of carrier aggregation, terminal device 100 initiates data communication with base station 200 using carrier aggregation of LTE and HSDPA (sequence SQ122).

The example of FIG. 9 corresponds to the case where a particular carrier of WCDMA is first detected by a cell search. In other words, FIG. 8 represents the processing example when terminal device 100 has camped on in LTE, whereas FIG. 9 represents the processing example when terminal device 100 has camped on in WCDMA. The point of difference between FIGS. 8 and 9 lies in that communication control is executed through LTE in the communication procedures shown in FIG. 8 whereas communication control is executed through WCDMA in the communication procedures shown in FIG. 9.

Specifically, the example shown in FIG. 9 corresponds to the case where a carrier of WCDMA is first detected by a cell search (sequence SQ105). Accordingly, terminal device 100 notifies base station 200 about its own terminal capability information 300 through WCDMA (sequence SQ107). This terminal capability information 300 is typically notified as a part of general information indicating the terminal capability (UE Capability in WCDMA). Namely, terminal device 100 notifies base station 200 about terminal capability information 300 indicating whether communication is allowed using a plurality of wireless transmission methods simultaneously. At this stage, terminal device 100 adds terminal capability information 300 to UE Capability for transmission.

Base station 200 transmits to terminal device 100 a response to the notification of terminal capability information 300 through WCDMA (sequence SQ111). Then, terminal device 100 attains a standby state in WCDMA (sequence SQ113).

Upon generation of a transmission request of a packet, voice, or the like (sequence SQ114), terminal device 100 requests a communication connection to base station 200 through the WCDMA currently camped on (sequence SQ117). Accordingly , base station 200 determines the resource to be allocated to terminal device 100 from radio resources available at each of the plurality of wireless transmission methods, based on terminal capability information 300 notified by terminal device 100. In this case, base station 200 selects usage of carrier aggregation. Then, base station 200 notifies terminal device 100 of a selected state of carrier aggregation through WCDMA (sequence SQ121).

According to the communication procedures of the first embodiment set forth above, it is necessary to allow notification of terminal capability information 300 of terminal device 100 in the wireless transmission method of both LTE and WCDMA. As one method of realizing this, terminal capability information 300 is to be added to both UE Capability of LTE and UE Capability of WCDMA, for example. In other words, terminal device 100 notifies terminal capability information 300 in each of the plurality of wireless transmission methods.

By employing such a method, terminal capability information 300 from terminal device 100 to base station 200 can be notified, regardless of which wireless transmission method of LTE and WCDMA terminal device 100 has camped on. Therefore, radio resource allocation can be performed with flexibility.

### F. Second Embodiment

The first embodiment set forth above is based on an exemplified configuration in which terminal capability information 300 of terminal device 100 can be notified in both the LTE and WCDMA wireless transmission method. A configuration in which terminal capability information 300 of terminal device 100 is notified through only one of the wireless transmission methods may be employed. The second embodiment is directed to the communication procedures when such a configuration is employed.

By way of example in the second embodiment, description will be provided envisaging notification of terminal capability information 300 of terminal device 100 only through LTE. According to the description set forth below, it is apparent that a similar method can be employed in the case where terminal capability information 300 of terminal device 100 is notified through WCDMA alone.

More specifically, a likely case is where terminal capability information 300 is added to UE Capability of LTE, and is not added to UE Capability of WCDMA (existing UE Capability is used without any change).

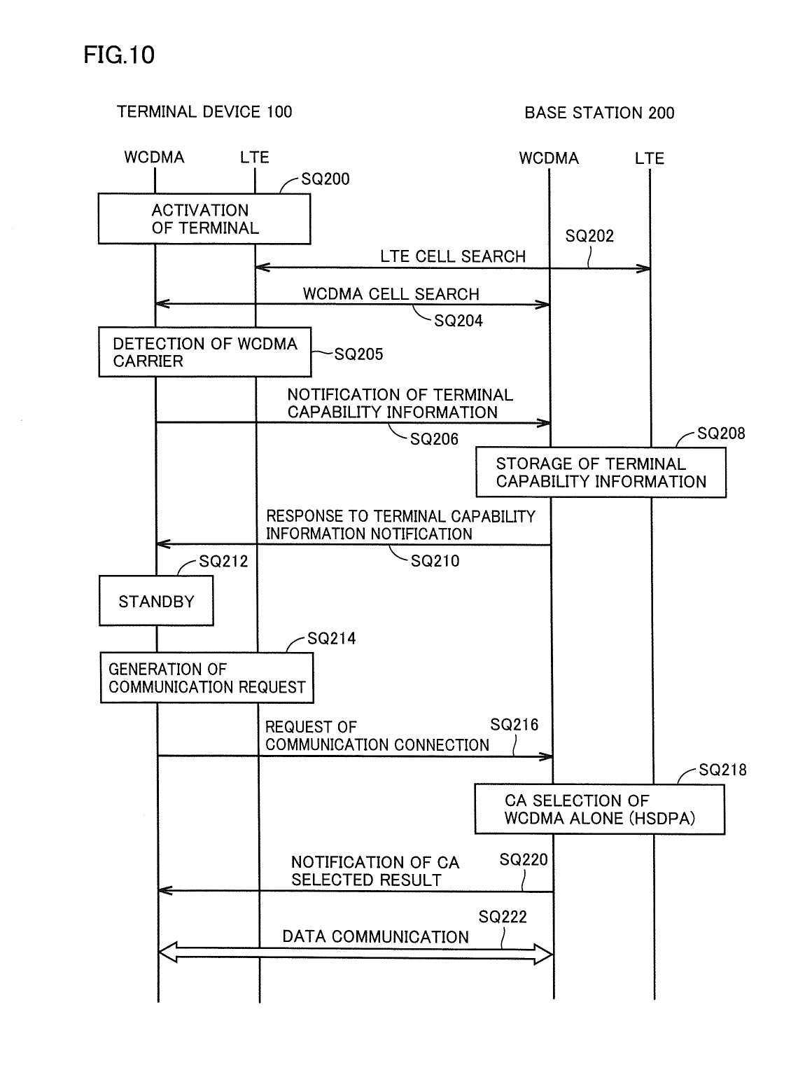

FIG. 10 is a sequence chart representing communication procedures of a wireless communication system according to the second embodiment. Referring to FIG. 10, when terminal device 100 is activated by a power button being turned ON or the like (sequence SQ200), terminal device 100 initiates a cell search (sequence SQ202). In the second embodiment, first a cell search of LTE is performed. When a particular carrier in LTE is detected, communication procedures similar to those shown in the sequence chart of FIG. 8 set forth above are executed. Therefore, the details of this situation will not be repeated.

In contrast, when no carrier in LTE was detected in the LTE cell search, terminal device 100 performs a cell search in WCDMA (sequence SQ204). Then, it is assumed that a particular carrier in WCDMA is detected (sequence SQ205). In the case where a carrier in WCDMA is also not detected, terminal device 100 is out of the range.

When a carrier in WCDMA is detected, terminal device 100 notifies base station 200 about UE Capability (sequence SQ206). It is to be noted that this UE Capability does not include terminal capability information 300, differing from the first embodiment set forth above.

Upon receiving UE Capability from terminal device 100 through WCDMA, base station 200 stores the received UE Capability in terminal capability storage unit 112, together with the information to identify terminal device 100 that is the transmission source (sequence SQ208). Since UE Capability does not include terminal capability information 300, base station 200 cannot determine under this status whether terminal device 100 of interest is capable of carrier aggregation of LTE and WCDMA.

Base station 200 transmits to terminal device 100 a response to the notification of terminal capability information 300 through WCDMA (sequence SQ210). Then, terminal device 100 attains a standby state through WCDMA (sequence SQ212).

When a communication request of a packet, voice, or the like is generated (sequence SQ214), terminal device 100 requests a communication connection to base station 200 through WCDMA currently camped on (sequence SQ216). For example, consider the case where a communication request of a packet of a large data size is generated, and data connection is requested. As described in the first embodiment set forth above, various information related to scheduling may be notified together with a data connection request.

Scheduling processing unit 216 of base station 200 determines whether carrier aggregation of LTE and WCDMA (HSDPA) is to be performed or not based on various information notified by terminal device 100, the entire traffic amount, UE Capability, and the like. For this determination method, a determination method similar to that described above in the first embodiment may be employed. It is to be noted that since the target terminal device 100 cannot determine whether carrier aggregation of LTE and WCDMA is possible or not, scheduling processing unit 216 of base station 200 selects communication through WCDMA (HSDPA) alone, not using LTE.

FIG. 10 represents an example in which a communication connection of a large data size is requested. In this example, scheduling processing unit 216 of base station 200 selects performing carrier aggregation through WCDMA (HSDPA) alone (sequence SQ218). In other words, base station 200 determines a resource to be allocated to terminal device 100 from radio resources in each of the plurality of wireless transmission methods based on terminal capability information 300 notified by terminal device 100. Then, base station 200 notifies terminal device 100 about the selected result of carrier aggregation through WCDMA (sequence SQ220).

According to the notified selected result of carrier aggregation, terminal device 100 initiates data communication with base station 200 using carrier aggregation of HSDPA (sequence SQ222). Although the communication procedures shown in FIGS. 8 and 9 set forth above correspond to the case where data communication is performed using carrier aggregation of LTE and HSDPA, the communication procedures shown in FIG. 10 according to the second embodiment correspond to data communication using HSDPA alone.

Although carrier aggregation of LTE and HSDPA cannot be selected in this case, carrier aggregation by HSDPA alone becomes the best selection since terminal device 100 is located in an area that cannot be connected to LTE. Thus, by employing the communication procedures according to the second embodiment, radio resource allocation can be performed with flexibility by adding terminal capability information 300 only to UE Capability of LTE, and not to the existing UE Capability of WCDMA.

In other words, terminal device 100 notifies terminal capability information 300 in a specific wireless communication system (in the example set forth above, the LTE method) among a plurality of wireless transmission methods. At this stage, terminal device 100 performs a cell search on a particular wireless transmission method notified by terminal capability information 300, giving priority over another wireless communication system (in the example set forth above, the WCDMA method).

A carrier of LTE may be searched for periodically, and camped on, when detected, given priority over WCDMA. By employing such a method, the allocation of a wireless source can be performed always with flexibility.

Furthermore, terminal capability information 300 may be added to UE Capability of WCDMA alone, and not added to the existing UE Capability of LTE. In this case, by procedures similar to those of the communication procedures shown in FIG. 10, allocation of a radio resource can be performed with priority by a cell search first for WCDMA.

When position registration is to be conducted at both the LTE and WCDMA wireless transmission methods in the activation of terminal device 100, terminal capability information 300 can be sent to base station 200 through one relevant wireless transmission method by insertion to UE Capability of at least one of LTE and WCDMA. Therefore, no problem will occur.

Thus, as one communication method of terminal capability information 300 described above, terminal capability information 300 is added to only UE Capability of LTE. As the communication procedures, terminal device 100 attempts to camp on at LTE. When terminal device 100 can camp on at LTE, terminal capability information 300 can be sent to base station 200 (network side) through the UE Capability of LTE. In contrast, in the case where terminal device 100 cannot camp on at LTE, terminal device 100 camps on at WCDMA (HSDPA). In this case, although terminal capability information 300 cannot be notified to base station 200 (network side), there is no particular problem since terminal capability information 300 corresponds to the case where carrier aggregation of LTE and WCDMA is not allowed.

### G. Third Embodiment

The first and second embodiments set forth above correspond to examples of notifying terminal capability information 300 from terminal device 100 to base station 200 by using UE Capability including terminal capability information 300. Instead of such configuration in which terminal device 100 notifies terminal capability information 300 voluntarily, a configuration in which base station 200 request terminal device 100 of terminal capability information 300 can be employed.

For example, base station 200 may ask terminal device 100 about whether communication at WCDMA (HSDPA) is allowed or not (and whether carrier aggregation of LTE and WCDMA (HSDPA) is allowed or not), and if terminal device 100 responds that communication is allowed, base station 200 may perform scheduling for carrier aggregation of LTE and WCDMA (HSDPA).

### H. Fourth Embodiment

The first to third embodiments set forth above are described based on examples of defining UE Capability of WCDMA by adding terminal capability information 300. In this case, base station 200 (network side) can directly read terminal capability information 300 via WCDMA. However, there is a possibility of various improvements being made in association with further development in LTE. The fourth embodiment is directed to a configuration of defining by capsulating UE Capability related to LTE to UE Capability of WCDMA. This extended UE Capability directed to LTE has been prepared for extension towards future use. The system of WCDMA can only identify that the information added in the form of a capsule is UE Capability directed to LTE.

### h1: Structural Example of Terminal Capability Information

In the fourth embodiment, UE Capability directed to LTE, transmitted from terminal device 100, includes any of terminal capability information 300 shown in FIGS. 5 and 6 set forth above, in addition to the information included in the existing UE Capability.

In contrast, UE Capability of WCDMA transmitted from terminal device 100 includes, in addition to information included in the existing UE Capability, any of terminal capability information 300 shown in FIGS. 5 and 6 set forth above in the form of a capsule.

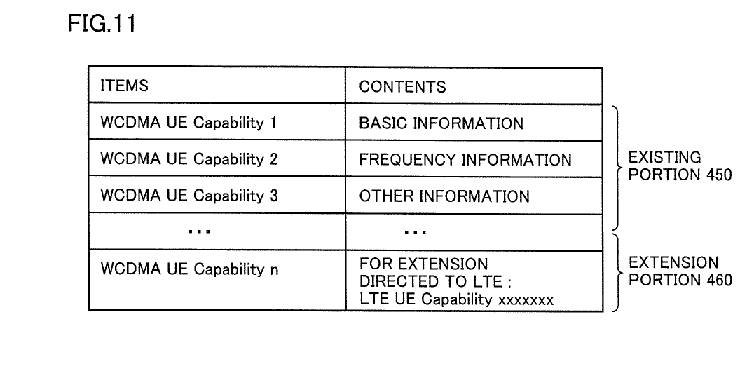

FIG. 11 is a schematic diagram representing an example of UE Capability of WCDMA transmitted from terminal device 100 according to the fourth embodiment. UE Capability of WCDMA shown in FIG. 11 includes an existing portion 450 and an extension portion 460.

“WCDMA UE Capability 1”, “WCDMA UE Capability 2”, “WCDMA UE Capability 3” . . . included in existing portion 450 indicate information defined in the current 3GPP specification such as basic information, frequency information, and other information.

Extension portion 460 includes “WCDMA UE Capability n”, which corresponds to terminal capability information 300. “WCDMA UE Capability n” (extension portion 460) has terminal capability information 300 shown in FIGS. 5 and 6 set forth above inserted in the form of a capsule. Moreover, various other terminal capability information 300 directed to LTE may be inserted in the form of a capsule.

Thus, extension portion 460 is an extension to existing UE Capability. In other words, extension portion 460 corresponding to a portion of UE Capability of WCDMA substantially indicates extended UE Capability directed to LTE. Although that information is recognized as information directed to LTE from the standpoint of the system of WCDMA, the contents are rendered such that they cannot be decoded immediately. In other words, the information is set in a capsulated state when viewed from the part of the system of WCDMA.

Extension portion 460 is used only in the case requiring LTE-directed extension. For example, if the terminal device does not accommodate LTE, “WCDMA UE Capability n” does not have to be notified since the information of extension portion 460 is not required.

Thus, terminal capability information 300 related to LTE of terminal capability information 300 (or UE Capability including terminal capability information 300) is inserted in the form of a capsule to UE Capability of WCDMA (HSDPA). Specifically, a UE Capability region related to LTE is provided in the UE Capability region of HSDPA. Although that information is recognized as information directed to LTE from the standpoint of the system of HSDPA, the contents are rendered such that they cannot be decoded immediately. Thus, terminal device 100 capsulates and inserts the terminal information related to one wireless transmission method to UE Capability of another wireless transmission method.

### h2: Communication Control Method

A communication control method when UE Capability of LTE and WCDMA set forth above will be described hereinafter.

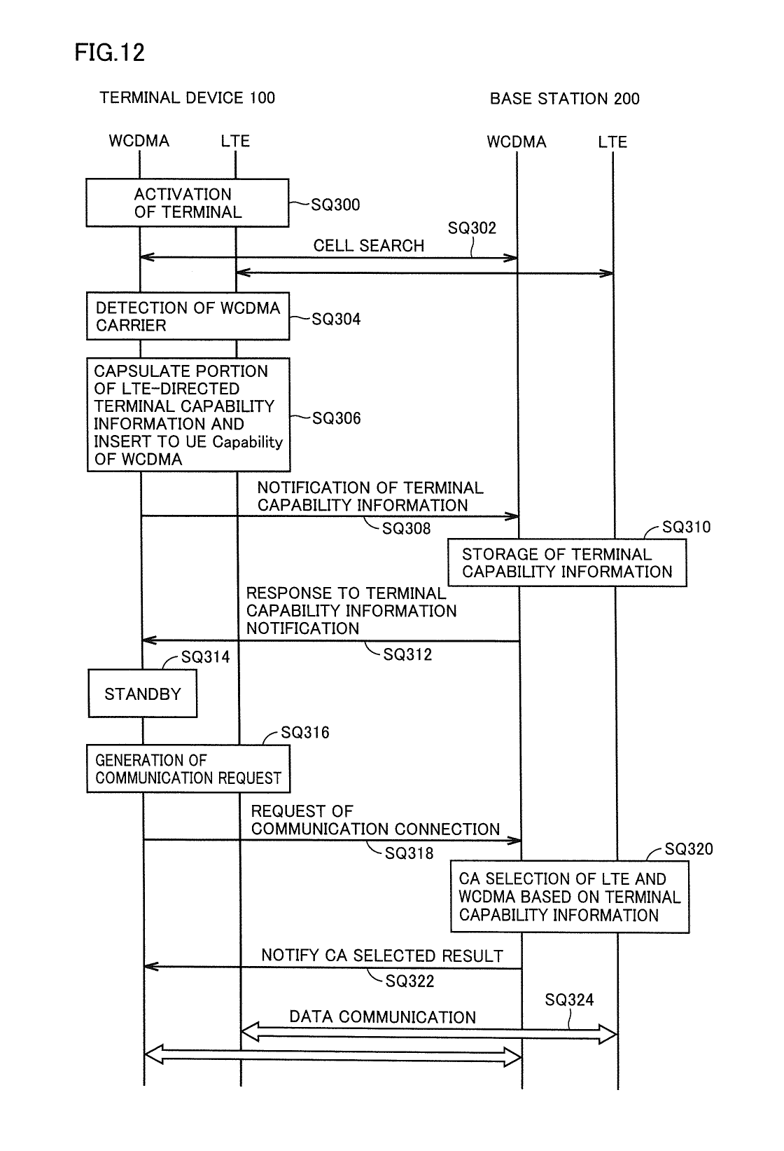

FIG. 12 is a sequence chart representing communication procedures in the wireless communication system according to the fourth embodiment. When terminal device 100 is activated by a power button being turned ON or the like (sequence SQ300), terminal device 100 initiates a cell search (sequence SQ302). When a particular carrier in LTE is detected at this stage, communication procedures similar to those indicated in the sequence chart of FIG. 8 set forth above are executed. Detailed description thereof will not be repeated here.

When a particular carrier in WCDMA is detected (sequence SQ304), terminal device 100 capsulates a portion of terminal capability information 300 directed to LTE (UE Capability), and inserts that capsule to UE Capability of WCDMA (sequence SQ306). Base station 200 is notified of UE Capability of WCDMA subsequent to insertion (sequence SQ308). In other words, terminal device 100 notifies base station 200 about UE Capability of WCDMA shown in FIG. 11.

Upon receiving UE Capability from terminal device 100 through WCDMA, base station 200 decodes the received UE Capability to extract terminal capability information 300, and stores the extracted information in terminal capability storage unit 112 together with information directed to identifying terminal device 100 that is the transmission source (sequence SQ310). Since UE Capability does not include terminal capability information 300, base station 200 cannot identify whether terminal device 100 of interest is capable of carrier aggregation of LTE and WCDMA at the current stage. However, extended terminal capability information 300 directed to LTE is sent from the system of WCDMA of base station 200 through LTE to be decoded at the LTE system side. Such decoded extended terminal capability information 300 directed to LTE is stored in terminal capability storage unit 214 together with terminal capability information 300 decoded at the WCDMA side.

In the case where the base station configuration of intrasite carrier aggregation shown in FIG. 4 is employed, UE Capability notified through WCDMA is transferred through aforementioned LTE-WCDMA base station interconnection 290.

Referring to FIG. 12 again, base station 200 transmits to terminal device 100 through WCDMA a response to the notification of terminal capability information 300 (sequence SQ312). Then, terminal device 100 attains a standby state through WCDMA (sequence SQ314).

When a communication request of a packet, voice or the like is generated (sequence SQ316), terminal device 100 requests a communication connection to base station 200 through its currently camped on WCDMA (sequence SQ318).

Scheduling processing unit 216 of base station 200 determines whether carrier aggregation of LTE and WCDMA (HSDPA) is to be performed or not based on the radio quality of a cell capable of communication, the entire traffic amount, whether the data that is the subject of transmission/reception is a packet or voice (and the data size in the case where the data that is the subject of transmission/reception is a packet), corresponding terminal capability information 300, and the like.

FIG. 12 represents an example in which communication connection of a large data size is requested. In this example, scheduling processing unit 216 of base station 200 selects performing carrier aggregation of WCDMA (HSDPA) alone (sequence SQ320). Then, base station 200 notifies terminal device 100 of a selected result of carrier aggregation through WCDMA (sequence SQ322).

Terminal device 100 initiates data communication with base station 200 using carrier aggregation of HSDPA according to the notified selected result of carrier aggregation (sequence SQ324).

### h3: Modification

The fourth embodiment set forth above is based on an example of definition with terminal capability information 300 directed to LTE for extension (UE Capability) added to UE Capability of WCDMA. A method other than the method of additional definition can be employed. For example, by capsulating and inserting terminal capability information 300 (UE Capability) directed to LTE to an uplink control signal and/or data signal of WCDMA, base station 200 may be notified independent of the existing UE Capability. When inserting in the form of a capsule, preferably which system of a wireless transmission method the capsuled result should be transmitted to is explicitly indicated.

Although the fourth embodiment set forth above is based on an example of inserting terminal capability information 300 (UE Capability) directed to LTE in the form of a capsule to UE Capability of WCDMA, terminal capability information 300 (UE Capability) directed to WCDMA may be inserted in the form of a capsule to UE Capability of LTE. Thus, by defining terminal capability information 300 common between a plurality of wireless transmission methods in the main wireless transmission method, and setting the terminal capability information in the form of a capsule for another wireless transmission method, extra information does not have to be defined. Communication control of favorable flexibility and efficiency can be realized.

Although a process of capsulating terminal capability information 300 (UE Capability) has been described in the fourth embodiment set forth above, communication control of high flexibility and efficiency can be realized by forming a capsule similar to other control signals, in addition to terminal capability information 300.

For example, consider the case where communication is performed in which carrier aggregation of LTE and WCDMA is performed for the downlink and using only LTE for the uplink. In this case, an ACK/NACK signal for data signals on the downlink of LTE is to be transmitted in accordance with the existing method at the uplink of LTE. In contrast, an ACK/NACK signal for data signals on the downlink (HSDPA) of WCDMA must be transmitted through the uplink of LTE since there is no existing uplink of WCDMA. As the transmission procedures thereof, the method set forth below, for example, may be employed.

First, terminal device 100 capsulates a control signal of WCDMA, assigns an address for WCDMA, and inserts the capsule to the control signal of an uplink of LTE. Alternatively, terminal device 100 may insert into the data signal of an uplink of LTE, which is transmitted to base station 200 through LTE.

Upon receiving the aforementioned control signal or data signal for LTE at an LTE reception unit, base station 200 decodes the capsulated signals via WCDMA, addressed for WCDMA.

### h4: Advantage

As described in the fourth embodiment set forth above, UE Capability of WCDMA notification is sent to base station 200 (network side) when terminal device 100 first camps on at WCDMA, whereas terminal capability information 300 (UE Capability) capsulated for LTE is notified from the network of the WCDMA side to the network of the LTE side. At the LTE side, the capsulated UE Capability is decoded. By employing such a method, UE Capability of existing WCDMA radio system does not have to be modified at every extension, so that communication control of high flexibility and efficiency can be realized.

### I. Other Embodiments

Although the first to fourth embodiments have been described based on a configuration of one base station 200 providing LTE and WCDMA, i.e. an exemplified configuration of an intrasite carrier aggregation, a configuration of intersite carrier aggregation may be employed. In other words, a configuration in which a plurality of base stations provide the services of LTE and WCDMA may be employed. Moreover, a plurality of base stations may be arranged in the system of LTE or WCDMA, and implement intersite carrier aggregation in each system.

Although an example of a combination of LTE and WCDMA has been described as the plurality of wireless transmission methods in the first to fourth embodiments, it is apparent that applicability to other wireless transmission methods is allowed.

For example, there is envisaged the case where terminal device 100 currently connected in WCDMA is capable of carrier aggregation of wireless LAN and HSDPA. In this case, terminal device 100 can include terminal capability information 300 (UE Capability) directed to wireless LAN as extension to UE Capability of WCDMA. Terminal capability information 300 directed to wireless LAN includes the corresponding wireless LAN specification (IEEE802.11a/b/g/n), corresponding frequency (2.4 GHz band and/or 5 GHz band), corresponding availability of MIMO, security scheme, and the like.

Base station 200 of WCDMA identifies a wireless LAN base station located around terminal device 100 from the position information and the like of terminal device 100, and can transmit a search request to the specified wireless LAN base station. According to the current specification, a search request in the C plane cannot be carried out. Therefore, the method of transmitting through the U plane, or defining extension of the format of C plane may be employed.

### J. Advantage

(1) The present embodiment is directed to a wireless communication system in which one or more terminal devices 100 and one or more base stations 200 are capable of using a plurality of wireless transmission methods simultaneously. Each terminal device 100 transmits to base station 200 terminal capability information 300 that is terminal information indicating whether communication using a plurality of wireless transmission methods simultaneously is allowed or not.

By employing such a configuration, base station 200 (network side) can allocate a radio resource appropriately to each terminal device based on information from terminal device 100 indicating whether communication using a plurality of wireless transmission methods simultaneously is allowed or not.

(2) In the present embodiment, terminal device 100 adds terminal capability information 300 including information indicating whether communication using a plurality of wireless transmission methods simultaneously is allowed or not to UE Capability, and notifies base station 200 of the same. In other words, terminal device 100 adds terminal capability information 300 to UE Capability of LTE and UE Capability of WCDMA.

By employing such a configuration, terminal capability information 300 can be notified using existing UE Capability, allowing the notification process of terminal capability information 300 to be simplified.

(3) In the present embodiment, terminal device 100 notifies terminal capability information 300 in each of a plurality of wireless transmission methods. Base station 200 can allocate a radio resource appropriately to a terminal device 100 based on terminal capability information 300 notified via the system of an arbitrary wireless transmission method. Namely, terminal device 100 adds terminal capability information 300 to both UE Capability of LTE and UE Capability of WCDMA.

By employing such a configuration, base station 200 can reliably receive terminal capability information 300, regardless of which wireless transmission method terminal device 100 has first been connected, among the plurality of wireless transmission methods.

(4) In the present embodiment, terminal device 100 may notify terminal capability information 300 in a particular wireless transmission method among the plurality of wireless transmission methods. At this stage, terminal device 100 performs a cell search for the particular wireless transmission method notifying terminal capability information 300, given priority over another wireless transmission method. Namely, terminal capability information 300 first searches for a cell of the system of the wireless transmission method that has terminal capability information 300 added to UE Capability. Upon detecting a subject cell, terminal device 100 notifies base station 200 about (UE Capability including) terminal capability information 300. Base station 200 allocates a radio resource to terminal device 100 based on terminal capability information 300 from terminal device 100. If a subject cell is not detected, a cell of a system of another wireless transmission method is searched for.

Thus, by employing a control method of initiating radio resource allocation upon notifying only a base station 200 providing a particular wireless transmission method about terminal capability information 300, and receiving terminal capability information 300 from terminal device 100 at base station 200, terminal capability information 300 related to a plurality of wireless transmission methods can be processed efficiently.

(5) In the present embodiment, terminal device 100 may notify terminal capability information 300 having defined for each of the downlink and uplink whether communication using a plurality of wireless transmission methods simultaneously is allowed or not.

In the present embodiment, terminal device 100 may notify a combination of frequency bands available in carrier aggregation as terminal capability information 300. For example, terminal capability information 300 includes information indicating those allowing simultaneously communication among a combination of arbitrary frequency bands of LTE and arbitrary frequency bands of WCDMA (HSDPA/HSUPA).

In the present embodiment, terminal device 100 may notify the number of frequency bands available in carrier aggregation (each maximum value and/or maximum value allowing simultaneous communication) as terminal capability information 300. For example, terminal capability information 300 includes information such as the maximum number of carriers available in carrier aggregation in LTE, the maximum number of carriers available in carrier aggregation in WCDMA, the maximum number of carriers available in carrier aggregation together between LTE and WCDMA. Such information may be defined individually for the reception capability and transmission capability of terminal device 100.

In the present embodiment, terminal device 100 notifies information about which wireless transmission method is to be given priority, and/or which frequency band is to be given priority, as terminal capability information 300.

By notifying further detailed contents as set forth as terminal capability information 300, base station 200 can allocate a radio source more appropriately to each terminal device 100.

(6) In the present embodiment, an extension region directed to future extension is provided in UE Capability. For this extension region, at least a portion of UE Capability (terminal capability information 300) directed to the system of another wireless transmission method is inserted in the form of a capsule. By employing such a configuration, UE Capability can be extended in a flexible manner.

More specifically, UE Capability including the information of whether communication using a plurality of wireless transmission methods simultaneously is allowed or not is capsulated and inserted into the aforementioned extension. Further, information of the address (for example, for LTE or the like) is also added.

Alternatively, terminal capability information 300 may be capsulated and included in an uplink control signal (for example, PUCCH (Physical Uplink Control Channel) in the case of LTE) and/or an uplink data signal (for example, PUSCH (Physical Uplink Shared Channel in the case of LTE). Further, information of the address (for example, for LTE or the like) is added.

By capsulating and inserting UE Capability (terminal capability information 300), a dedicated region to notify the information of whether communication using a plurality of wireless transmission methods simultaneously is allowed or not does not have to be provided, allowing a flexible control method to be realized.

(7) In the present embodiment, in the case where terminal device 100 first detects a cell provided by the system of a wireless transmission method corresponding to UE Capability to which terminal capability information 300 is not added, terminal device 100 capsulates and inserts terminal capability information 300 into the aforementioned extension region, and adds the required address for transmission to base station 200. Alternatively, terminal device 100 capsulates and inserts terminal capability information 300 to an uplink control signal or data signal, and adds the required address for transmission to base station 200. Upon receiving such capsulated information, base station 200 decodes the capsulated terminal capability information 300 via the system of the wireless transmission method specified as the address. Then, base station 200 allocates a radio resource based on the decoded terminal capability information 300.

By employing such a configuration, an appropriate base station 200 (network side) can be notified reliably about terminal capability information 300 even if terminal device 100 first detects a cell that provides the system of a wireless transmission method corresponding to UE Capability to which terminal capability information 300 is not added.

It is to be understood that the embodiments disclosed herein are only by way of example, and not to be taken by way of limitation. The scope of the present invention is not limited by the description above, but rather by the terms of the appended claims, and is intended to include any modifications within the scope and meaning equivalent to the terms of the claims.

### REFERENCE SIGNS LIST

100 terminal device; 110, 210, 210A, 210B control unit; 112, 214, 214A, 214B terminal capability storage unit; 114 terminal capability transmission processing unit; 120.1, 120.2, 220.1, 220.2 LTE transmission unit; 140.1, 140.2, 240.1, 240.2 LTE reception unit; 122.1, 122.2, 132.1, 132.2, 222.1, 222.2, 232.1, 232.2 transmission antenna; 130.1, 130.2, 230.1, 230.2 WCDMA transmission unit; 142.1, 142.2, 152.1, 152.2, 242.1, 242.2, 252.1, 252.2 reception antenna; 150.1, 150.2, 250.1, 250.2 WCDMA reception unit; 200, 260, 270 base station; 200A base station system; 212, 212A, 212B terminal capability reception processing unit; 216, 216A scheduling processing unit; 280 base station controller; 290 base station interconnection; 300, 300A, 300B, 300C terminal capability information; 400 core network; 450 existing portion; 460 extension portion; SYS wireless communication system.

1-12. (canceled)

13. A wireless communication system comprising:
at least one base station adapted to provide services in accordance with a plurality of wireless transmission methods respectively, and
a terminal device adapted to be connected to the base station,
the terminal device configured to notify the base station about terminal information indicating whether communication using the plurality of wireless transmission methods simultaneously is allowed or not,
the base station configured to determine a radio resource to be allocated to the terminal device from radio resources available in each of the plurality of wireless transmission methods, based on terminal information notified by the terminal device.

14. The wireless communication system according to claim 13, wherein the terminal device is further configured to notify the terminal information in each of the plurality of wireless transmission methods.

15. The wireless communication system according to claim 13, wherein the terminal device is further configured to notify the terminal information in a particular wireless transmission method from the plurality of wireless transmission methods.

16. The wireless communication system according to claim 15, wherein the terminal device is further configured to perform a cell search for the particular wireless transmission method notifying the terminal information, given priority over another wireless transmission method.

17. The wireless communication system according to claim 13, wherein the terminal device is configured to add the terminal information to UE Capability for transmission.

18. The wireless communication system according to claim 13, wherein the terminal information includes information defining an available wireless transmission method individually for a downlink and an uplink.

19. The wireless communication system according to claim 13, wherein the terminal information includes information indicating an available frequency band from frequency bands used in the plurality of wireless transmission methods.

20. The wireless communication system according to claim 19, wherein the terminal information includes information indicating which is to be given priority for at least one of wireless transmission methods and frequency bands.

21. The wireless communication system according to claim 13, wherein the terminal device is further configured to capsulate and insert terminal information related to one wireless transmission method to UE Capability of another wireless transmission method.

22. A wireless communication method of a wireless communication system including at least one base station adapted to provide services in accordance with a plurality of wireless transmission methods respectively, and a terminal device, the method comprising the steps of:
notifying terminal information indicating whether communication using a plurality of wireless transmission methods simultaneously is allowed or not from the terminal device to the base station, and
determining a radio resource to the allocated to the terminal device from radio resources available at each of the plurality of wireless transmission methods, based on the terminal information notified from the terminal device.

23. A terminal device connected to at least one base station adapted to provide services in accordance with a plurality of wireless transmission methods respectively, the terminal device configured to:
notify the base station about terminal information indicating whether communication using a plurality of wireless transmission methods simultaneously is allowed or not, and
perform communication using a radio resource allocated by the base station based on the terminal information.

24. A base station configured to:
provide services in accordance with a plurality of wireless transmission methods respectively,
receive, from a terminal device, terminal information indicating whether communication using a plurality of wireless transmission methods simultaneously is allowed or not, and
detect a radio resource to be allocated to a terminal device from radio resources available at each of the plurality of wireless transmission methods, based on terminal information notified from the terminal device.
